(19) United States
(12) Patent Application Publication
(10) Pub. No.: US 2011/0062200 A1
(43) Pub. Date: Mar. 17, 2011

(54) Handlebar attachment for bicycle

(76) Inventor: Ying Hui Liu, Changhua (TW)

(21) Appl. No.: 12/586,111

(22) Filed: Sep. 17, 2009

(51) Int. Cl. B62J 11/00

(52) U.S. Cl. 224/428

(57) ABSTRACT

A handlebar attachment includes a handlebar attached to an attaching device, and an article carrier having two housing members for receiving various objects and coupled together at the front portions with a connecting panel for attaching the housing members to the attaching device, and the article carrier includes two fastening devices for attaching the housing members to the handlebar and for allowing the objects received in the housing members to be easily obtained by the user when the user is riding the bicycle, and the article carrier includes two carrying straps for carrying the housing members when the housing members of the article carrier are disengaged from the attaching device and the handlebar.

### BACKGROUND OF THE INVENTION

1. Field of the Invention

The present invention relates to a handlebar attachment for bicycle, and more particularly to a handlebar attachment including an article carrier for receiving various objects and for easily and quickly attaching to a handlebar of the bicycle, and for allowing the various objects to be easily obtained by the user when the user is riding the bicycle.

2. Description of the Prior Art

Typical handlebars for bicycles comprise a horizontal tube attached to top of a vertical tube or steering tube, and a handlebar attached to the horizontal tube for being grasped or held by the user, particularly when the user is riding the bicycle.

For example, U.S. Pat. No. 5,331,865 to Oskam, U.S. Pat. No. 5,373,757 to Bigall, U.S. Pat. No. 5,408,900 to Marui, and U.S. Pat. No. 5,536,104 to Chen disclose four of the typical handlebars for bicycles each also comprising a horizontal stem attached to top of a vertical tube or steering tube, and a handlebar attached onto the front portion of the horizontal stem for being grasped or held by the user.

However, the vertical tube or steering tube is designed and provided for attaching or supporting the horizontal stem and may not be used or provided for attaching or supporting the other objects. Normally, a carrying case or bag is required to be provided and attached to the rear carrier rack of the bicycle for receiving various objects. However, the objects received in the carrying case or bag are disposed on the rear carrier rack of the bicycle and may not be easily obtained by the user, particularly when the user is riding the bicycle.

The present invention has arisen to mitigate and/or obviate the afore-described disadvantages of the conventional handlebar attachments for the bicycles.

### SUMMARY OF THE INVENTION

The primary objective of the present invention is to provide a handlebar attachment including an article carrier for receiving various objects and for easily and quickly attaching to a handlebar of the bicycle, and for allowing the various objects to be easily obtained by the user when the user is riding the bicycle.

In accordance with one aspect of the invention, there is provided a handlebar attachment comprising an attaching device, a handlebar attached to the attaching device, and an article carrier including two housing members having front portions coupled together with a connecting panel for forming a space between the housing members and for receiving and engaging with the attaching device and for attaching the housing members of the article carrier to the attaching device, and the article carrier including two fastening devices attached to rear portions of the housing members respectively for engaging with the handlebar and for attaching the housing members to the attaching device, and the article carrier including two carrying straps attached to the housing members respectively for carrying the housing members of the article carrier when the housing members of the article carrier are disengaged from the attaching device.

The article carrier includes a pouch attached to the front portion of the article carrier for receiving the mobile phones or the like. The pouch includes an upper portion pivotally attached to the front portion of the article carrier with a hinge, and includes a lower portion coupled to the front portion of the article carrier with an extendible member for allowing the lower portion of the pouch to be selectively tilted relative to the article carrier and for allowing the mobile phones to be easily obtained by the user when the user is riding the bicycle.

The article carrier includes two fixing devices attached to the pouch and the front portion of the article carrier respectively for allowing the lower portion of the pouch to be selectively secured to the front portion of the article carrier with the fixing devices.

The article carrier includes two casings provided in the housing members respectively for receiving the carrying straps respectively.

The article carrier includes a cover openably attached to each of the housing members with a securing device. The article carrier includes an auxiliary bag attached to each of the covers for receiving the other objects.

The article carrier includes two fixing devices attached to the rear portions of the housing members respectively and engageable with each other for securing the rear portions of the housing members together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a handlebar attachment in accordance with the present invention;

FIG. 2 is a partial front perspective view illustrating the operation of the handlebar attachment for the bicycle;

FIG. 3 is a perspective view illustrating the operation of the handlebar attachment for the bicycle;

FIG. 4 is a partial side plan schematic view of the handlebar attachment for the bicycle; and

FIG. 5 is another partial side plan schematic view similar to FIG. 4, illustrating the operation of the handlebar attachment for the bicycle.

### DETAILED DESCRIPTION OF THE PREFERRED EMBODIMENT

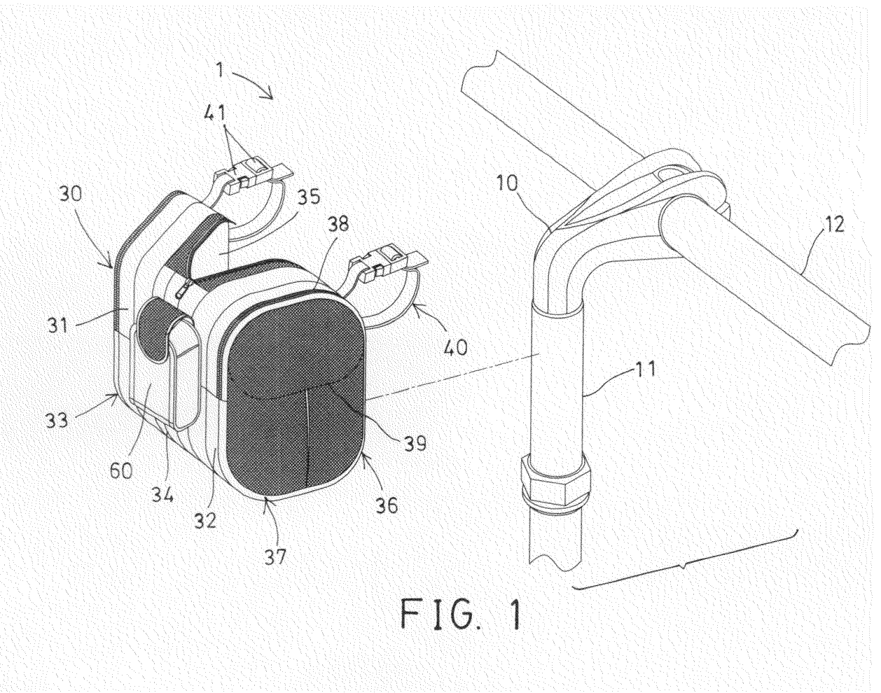

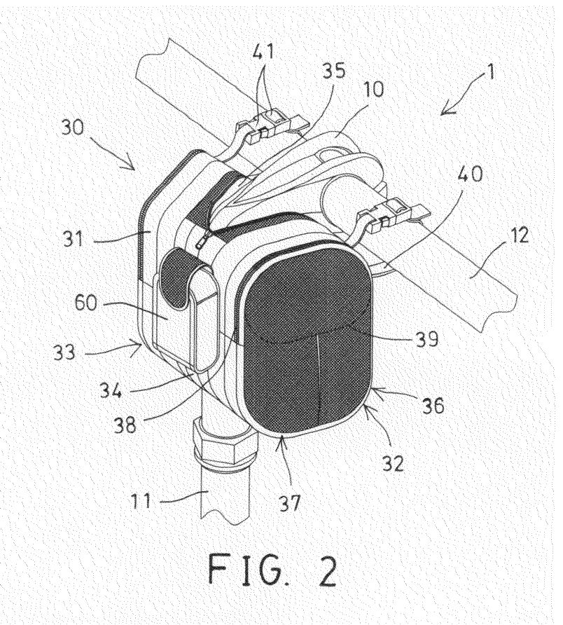

Referring to the drawings, and initially to FIGS. 1-3, a handlebar attachment 1 in accordance with the present invention comprises a horizontal tube or attaching device 10 to be attached to or disposed on top of a steering tube or vertical tube 11 of a bicycle, and a handlebar 12 attached to the horizontal tube or attaching device 10 for being grasped or held by the user. The above-described attaching structure of the handlebar 12 to the horizontal tube or attaching device 10 is typical and will not be described in further details.

The handlebar attachment 1 further comprises an article carrier 30 including two bags or housing members 31, 32 for receiving various objects therein and having a front portion 33 coupled together with a connecting panel 34 for forming a space 35 between the housing members 31, 32 and for receiving or engaging with the attaching device 10 and/or the vertical tube 11 and for easily and quickly attaching the housing members 31, 32 of the article carrier 30 onto the attaching device 10 and/or the vertical tube 11.

The article carrier 30 further includes one or more fastening straps or devices 40 mounted or attached to the rear portion 36 of each of the housing members 31, 32 for engaging with the handlebar 12, and for further quickly and solidly attaching or securing the housing members 31, 32 of the article carrier 30 to the attaching device 10 and/or the handlebar 12 with buckles 41. The article carrier 30 may include one or more compartments or covers 37 openably attached to each of the housing members 31, 32 with a securing device 38, such as zippers 38, and may include one or more auxiliary bags 39 attached to the side portion of each of the housing members 31, 32 or attached to the cover 37.

In operation, as shown in FIGS. 1-3, the housing members 31, 32 of the article carrier 30 may be easily and quickly attached to the attaching device 10 and/or the handlebar 12 by engaging the attaching device 10 into the space 35 between the housing members 31, 32, and/or by engaging the fastening straps or devices 40 with the handlebar 12, and the housing members 31, 32 of the article carrier 30 will be supported in front of the user such that the various objects received in the housing members 31, 32 of the article carrier 30 and/or in the auxiliary bags 39 may be easily and quickly obtained by the user when the user is riding the bicycle.

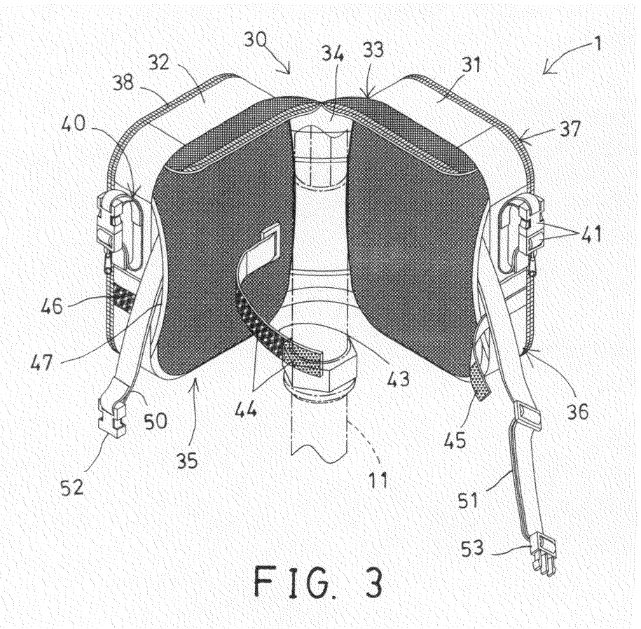

The article carrier 30 may further include another anchoring strap or device 43 mounted or attached to one of the housing members 32 (FIG. 3) and having hook and loop engaging or locking or fastening members 44 for further firmly attaching or mounting the housing members 31, 32 onto the vertical tube 11, and may further include two hook and loop or fixing straps or devices 45, 46 mounted or attached to the housing members 31, 32 respectively (FIG. 3), in which the fixing straps or devices 45, 46 may be engaged with each other for fixing or securing the rear portions 36 of the housing members 31, 32 together when required.

The article carrier 30 may further include a compartment or casing 47 formed or provided in or on the inner portion of each of the housing members 31, 32 for receiving a carrying strap 50, 51 (FIG. 3) which may be removed or extended out of the casing 47 and coupled together with the female and the male buckles 52, 53, for allowing the housing members 31, 32 of the article carrier 30 to be easily or suitably carried by the user with the carrying straps 50, 51 and the female and the male buckles 52, 53 when the housing members 31, 32 of the article carrier 30 are disengaged from the attaching device 10 and/or the handlebar 12 and/or the vertical tube 11.

The article carrier 30 may further include a pocket or pouch 60 attached to the front portion 33 or the connecting panel 34 of the article carrier 30 (FIGS. 1-2, 4-5) for receiving various objects, such as mobile phones (not shown), for example, the pouch 60 includes one end or one side or an upper portion 61 pivotally or foldably attached or coupled to the front portion 33 or the connecting panel 34 of the article carrier 30 with a hinge 62, and includes the other end or the other side or a lower portion 63 coupled to the front portion 33 or the connecting panel 34 of the article carrier 30 with an extendible or foldable member 64 for allowing the lower portion 63 of the pouch 60 to be selectively tilted relative to the article carrier 30 (FIG. 5) and for allowing the mobile phones to be easily and quickly reached or obtained by the user when the user is riding the bicycle.

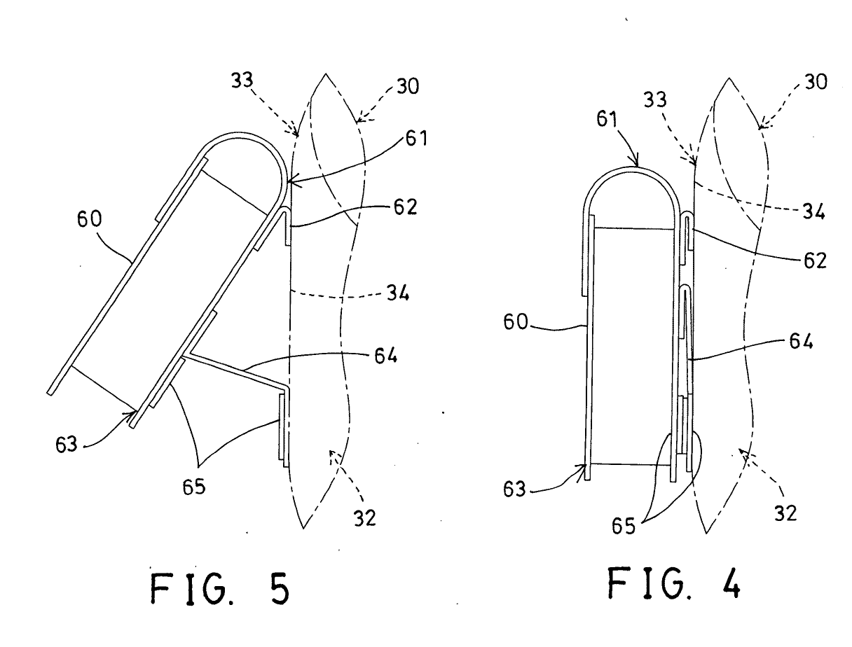

The article carrier 30 may further include two hook and loop or fixing straps or devices 65 mounted or attached to the pouch 60 and the housing members 31, 32 or the front portion 33 or the connecting panel 34 of the article carrier 30 respectively for allowing the lower portion 63 of the pouch 60 to be selectively coupled or secured to the front portion 33 or the connecting panel 34 of the article carrier 30 with the hook and loop or fixing straps or devices 65 (FIG. 4).

Accordingly, the handlebar attachment in accordance with the present invention includes an article carrier for receiving various objects and for easily and quickly attaching to a handlebar of the bicycle, and for allowing the various objects and/or the mobile phones to be easily obtained by the user when the user is riding the bicycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A handlebar attachment comprising:
an attaching device,
a handlebar attached to said attaching device, and
an article carrier including two housing members having front portions coupled together with a connecting panel for forming a space between said housing members and for receiving and engaging with said attaching device and for attaching said housing members of said article carrier to said attaching device, and said article carrier including two fastening devices attached to rear portions of said housing members respectively for engaging with said handlebar and for attaching said housing members to said attaching device and said handlebar, and said article carrier including two carrying straps attached to said housing members respectively for carrying said housing members of said article carrier when said housing members of said article carrier are disengaged from said attaching device.

2. The handlebar attachment as claimed in claim 1, wherein said article carrier includes a pouch attached to said front portion of said article carrier.

3. The handlebar attachment as claimed in claim 2, wherein said pouch includes an upper portion pivotally attached to said front portion of said article carrier with a hinge, and includes a lower portion coupled to said front portion of said article carrier with an extendible member for allowing said lower portion of said pouch to be selectively tilted relative to said article carrier.

4. The handlebar attachment as claimed in claim 2, wherein said article carrier includes two fixing devices attached to said pouch and said front portion of said article carrier respectively for allowing said lower portion of said pouch to be selectively secured to said front portion of said article carrier with said fixing devices.

5. The handlebar attachment as claimed in claim 1, wherein said article carrier includes two casings provided in said housing members respectively for receiving said carrying straps respectively.

6. The handlebar attachment as claimed in claim 1, wherein said article carrier includes a cover openably attached to each of said housing members with a securing device.

7. The handlebar attachment as claimed in claim 6, wherein said article carrier includes an auxiliary bag attached to each of said covers.

8. The handlebar attachment as claimed in claim 1, wherein said article carrier includes two fixing devices attached to said rear portions of said housing members respectively and engageable with each other for securing said rear portions of said housing members together.
